(19) United States
(12) Patent Application Publication
(10) Pub. No.: US 2025/0065157 A1
(43) Pub. Date: Feb. 27, 2025

(54) Automated Breathing Air Trailer System

(71) Applicants: Phyl Mason, Beaumont (CA); Cory Lebrun, Calgary (CA)

(72) Inventors: Phyl Mason, Beaumont (CA); Cory Lebrun, Calgary (CA)

(21) Appl. No.: 18/452,816

(22) Filed: Aug. 21, 2023

(51) Int. Cl. A62B 9/02; A62B 7/02; A62B 9/00

(52) U.S. Cl. CPC A62B 9/02; A62B 7/02; A62B 9/006

(57) ABSTRACT

An automated breathing air trailer system. The automated breathing air trailer system provides a safe and reliable source of breathing air to workers in industrial confined spaces. The system includes at least two air control units arranged in parallel, each unit having an electronic device in communication with an automated control system that regulates the flow of air between the air sources and the supplied air breathing apparatus. Each air control unit includes a solenoid valve to control air flow and is connected to the electronic device and an interface for monitoring and controlling the system. The system also includes a manual bypass that circumvents the valve to ensure a continued supply of breathing air in case of valve failure or other issue.

### BACKGROUND OF THE INVENTION

The present invention relates to an automated breathing air trailer system and, more particularly, to an automated breathing air trailer system that will increase safety in industrial confined space environment (CSE) for workers in hazardous environments.

In the industrial setting, workers may encounter hazardous atmospheres, which necessitate the use of a supplied air breathing apparatus (SABA). Conventionally, breathing air is supplied from a breathing air trailer that houses several air cylinders connected to a manifold, which delivers constant air to multiple SABAs. However, the conventional air trailers suffer from several deficiencies that increase the risk of injury to workers in confined spaces.

One major deficiency of the conventional air trailer system is the need for a dedicated bottle watch to monitor the air cylinder levels. Conventionally, the air cylinders are independently connected, and a dedicated bottle watch is required to open a full bottle when one air cylinder is empty. This process is inefficient, as it requires a constant check of the air cylinders and a replacement of the empty cylinder, which increases the risk of exposure to hazardous atmospheres.

Additionally, the valve sequence in conventional air trailers is critical. If the empty cylinder is closed first, it cuts off the air supply to the SABA, which can result in the worker removing the SABA in a hazardous environment without any air supply. This valve sequence deficiency is a significant safety concern that can result in life-threatening situations.

Therefore, the purpose of the present invention is to address the deficiencies of the conventional air trailer systems by providing a reliable, safe, and efficient air breathing trailer system for use in confined spaces. The present invention seeks to enhance worker safety by eliminating the need for a dedicated bottle watch and providing a fail-safe valve sequence that guarantees a continuous supply of breathing air to the SABA. With these improvements, the present invention will significantly reduce the risk of injury and exposure to hazardous atmospheres in confined spaces, thereby enhancing worker safety and productivity.

In light of the devices disclosed in the known art, it is submitted that the present invention substantially diverges in design elements and methods from the known art and consequently it is clear that there is a need in the art for breathing air trailer systems. In this regard the instant invention substantially fulfills these needs.

### SUMMARY OF THE INVENTION

In view of the foregoing disadvantages inherent in the known types of breathing air trailer systems now present in the known art, the present invention provides a new automated breathing air trailer system that is designed to provide a reliable and safe supply of breathing air in industrial confined spaces. The system features an arrangement of air control units arranged in parallel that automatically detect the pressure at each air source and switch to a full air supply when the pressure drops, thus ensuring a continuous supply of breathing air to the SABA. An interface and display panel show the pressure levels throughout the system and the positions of each valve (open or closed) in real-time. In the event of a malfunction or error, the system triggers lights, and a sound to alert the workers.

One objective of the present invention is to provide an automated breathing air trailer system that reduces the risk of injury and exposure to hazardous atmospheres in industrial confined spaces. The system eliminates the need for a dedicated bottle watch, which significantly reduces the cost and increases the productivity of the workers.

It is also an objective of the present invention to provide a fail-safe valve sequence that guarantees a continuous supply of breathing air to the SABA. The system is designed to automatically switch to a full air supply when the pressure drops in any cylinder, thus preventing the SABA from being starved of air. The fail-safe valve sequence enhances worker safety and prevents life-threatening situations in hazardous environments.

Another objective of the present invention is to provide a real-time display of the pressure levels throughout the system and the positions of each valve (open or closed). The interface and display panel enable workers to monitor the air supply and detect any irregularities promptly. This feature enhances the safety of the workers by enabling them to take corrective measures before any significant problems arise.

It is an objective of the present invention to provide a system that triggers lights and a sound in the event of a malfunction or error. The lights and audible alert the workers to any problems, enabling them to take corrective measures promptly. This feature enhances worker safety by reducing the time it takes to detect and respond to malfunctions or errors.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a schematic view of an embodiment of the automated air breathing trailer system.

FIG. 2 shows a perspective view of an embodiment of an air control unit of the automated air breathing trailer system.

FIG. 3 shows a view of an embodiment of an interface of the automated air breathing trailer in a first configuration of the system.

FIG. 4 shows a view of an embodiment of an interface of the automated air breathing trailer in a second configuration of the system.

FIG. 5 shows a view of an embodiment of an interface of the automated air breathing trailer in a third configuration of the system.

FIG. 6 shows a view of an embodiment of an interface of the automated air breathing trailer in a fourth configuration of the system.

### DETAILED DESCRIPTION OF THE INVENTION

Reference is made herein to the attached drawings. For the purpose of presenting a brief and clear description of the present invention, the preferred embodiment will be discussed as used for providing breathing air in industrial confined spaces. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

As used herein, “computer-readable medium” or “memory” excludes any transitory signals, but includes any non-transitory data storage circuitry, e.g., buffers, cache, and queues, within transceivers of transitory signals. As used herein, “logic” refers to (i) logic implemented as computer instructions and/or data within one or more computer processes and/or (ii) logic implemented in electronic circuitry.

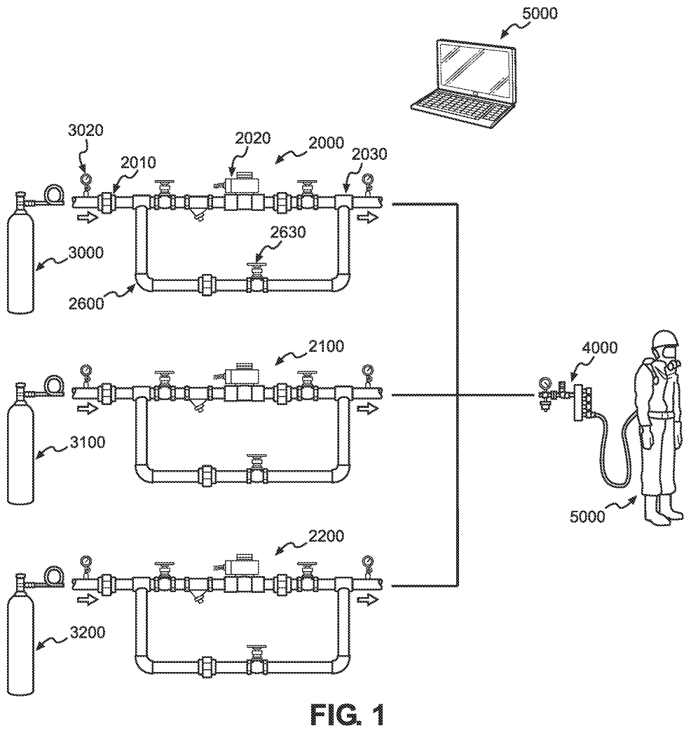

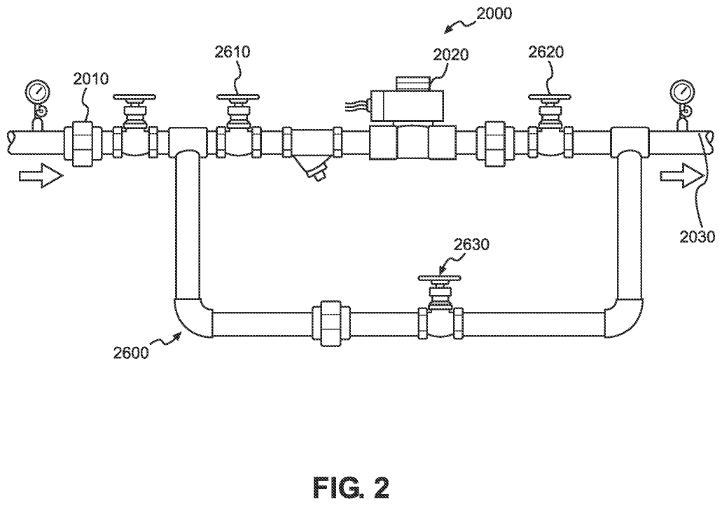

Referring now to FIGS. 1 and 2, there is shown a schematic view of an embodiment of the automated air breathing trailer system, and a perspective view of an embodiment of the air control unit of the automated air breathing trailer system, respectively. The automated breathing air trailer system 1000 provides a new system for providing air to workers in hazardous atmospheres. The automated breathing air trailer system 1000 comprises at least two air control units 2000, 2100 adapted to receive air from a first air source 3000 and a second air source 3100, respectively. In the shown embodiment, a third air control unit 2300 and a third air source 3300 are also shown. In some embodiments, the number of air control units and air sources are not limited to two or three.

In the shown embodiment, the first and second air sources 3000, 3100 are arranged in parallel to provide a continuous and reliable air supply to the breathing apparatus. The air source 3000 is in fluid communication with the first air control unit 2000, which is in turn in fluid communication with a manifold 4000. The manifold 4000 provides for multiple connections with outlets of each control unit and allows of multiple workers to connect with the supplied air. In the shown embodiment, the worker utilizes a SABA 5000 for receiving the supplied air. In alternative embodiments, the present invention is compatible with any downstream system that delivers air to the SABA 5000 may be compatible to the present invention.

In one embodiment, each air control unit 2000, 2100, 2200 includes one or more interconnected pipes with an inlet for receiving air from the air supply and an outlet for sending air. As used herein, “pipes” is synonymous with hoses or other mechanisms that fluidly transport air. In the shown embodiment, the inlet 2010 of the air control unit 2000 receives air from the first air source 3000, which is shown as a compressed air container. In alternative embodiments, the air sources may be any device that supplies air. The valve is provided in each air control unit to control the air flow between the inlet and outlet. The valve 2020 of the first air control unit 2000 is adapted to transition between an open position and a closed position, wherein the open position the valve allows air to flow from the air source 3000 through the valve 2020 and the outlet 2030. While in the closed position, the valve 2020 prevents air from flowing therethrough. In the shown embodiment, each valve of the air control units is independently controlled. In one embodiment, a pressure control device is used with each individual air source 3000, 3100, 3200 to provide for a pressure release.

In the shown embodiment, the valve 2020 comprises a solenoid valve that uses an electromechanical solenoid to control the flow of fluid through the air control unit. When an electrical current is applied to the solenoid coil, it generates a magnetic field that pulls a plunger or piston inside the solenoid. This movement of the plunger or piston opens or closes a port or valve inside the solenoid, which allows or stops the flow of fluid or gas through the pipe or passageway. In alternative embodiments, the valve comprises any suitable valve, such as a motor-operated valves and the like. In one embodiment, the valve is configured to fail open such that air is continued to be supplied regardless of a failure.

In the shown embodiment, each air control unit 2000 comprises a bypass 2600 that circumvents the valve 2020, wherein the bypass 2600 comprises a pair of stop valves 2610, 2620 positioned upstream and downstream of the valve 2020, and a bypass valve 2630 to divert air from the air source 2000 to the outlet 2030.

The bypass 2600 provides an alternative air flow path that circumvents the valve 2020 and allows the breathing air trailer system 1000 to continue supplying air to the supplied air breathing apparatus (SABA) in the event of a valve malfunction or failure. In the shown embodiment, the bypass 2600 is a manual bypass, with bypass stop valves 2610, 2620 that are manually operated. The bypass stop valves 2630 can be manually operated by the user to open or close the bypass as needed. In alternative embodiments, the bypass stop valves 2610 may be automated or partially automatic. The bypass 2600 can also be useful during routine maintenance or inspection of the system, allowing air to flow through the system while the valve 2020 is temporarily shut off. The use of a manual bypass in each air control unit 2000, 2100, 2200 provides an additional layer of safety and redundancy to the automated breathing air trailer system 1000, helping to ensure a reliable and consistent supply of breathing air to workers in industrial confined spaces.

In one embodiment, each air control unit further comprises a strainer positioned upstream of the valve. The strainer is designed to remove any impurities or debris present in the air before it reaches the supplied air breathing apparatus. In the shown embodiment, the strainer is located at the inlet of the air control unit, where it traps particles and contaminants as the air flows through it.

In one embodiment, a pressure gauge 3020 is positioned between the regulator and the first air source, so as to monitor the pressure in the piping. In the shown embodiment, the pressure gauge 3020 is a dial gauge with an indicator. In other embodiments, the pressure gauge 3020 is a digital gauge that is configured to communicate wirelessly with an electronic device 5000 having an interface run thereon. Moreover, each pressure gauge and valve are in wireless communication with the interface for remote control. The interface is adapted to be a graphical user interface that indicates each section of the system having controls for wirelessly controlling the valves, monitoring the pressures, and ensuring the consistent supply of air to the SABA(s). The interface is a human-machine interface which gives the ability for workers to manually override and open the valves if needed. The electronic device may be local to the air trailer or located remotely in a central control room via wired, or wireless (cellular/Bluetooth) connection.

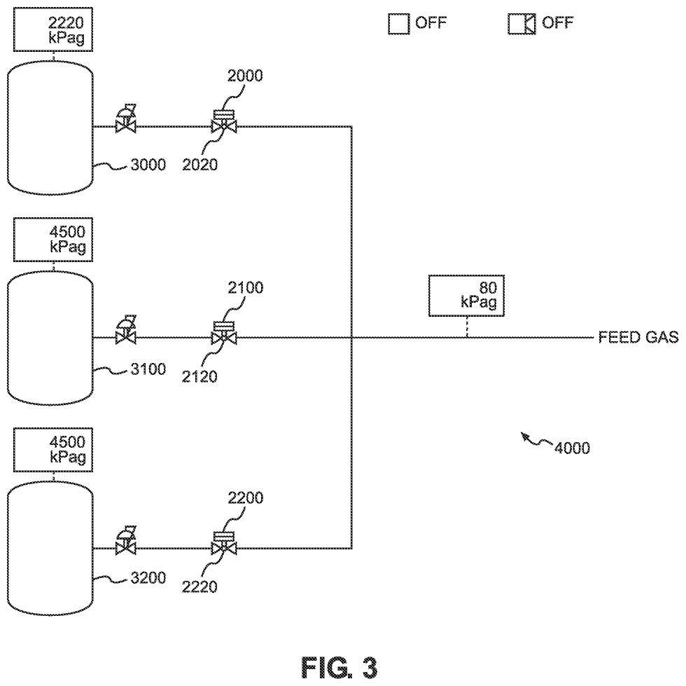

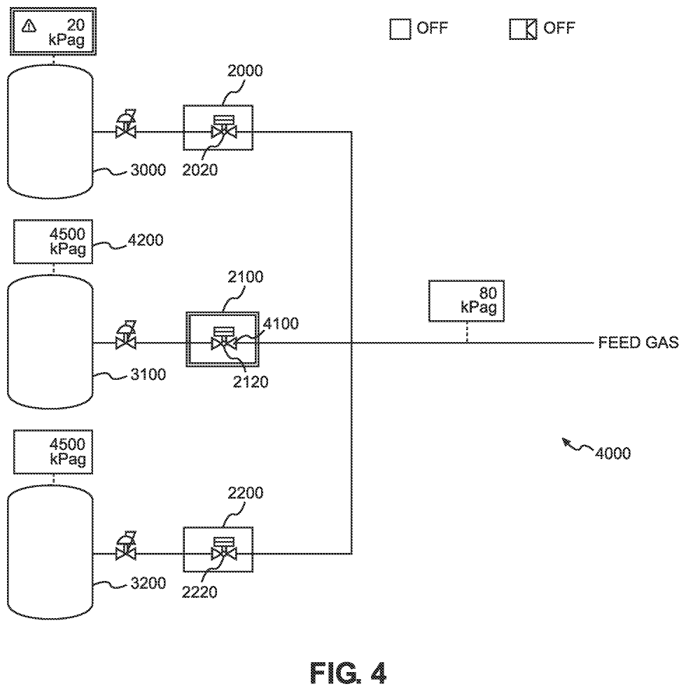

Referring now to FIGS. 3 and 4, there is shown a view of an embodiment of the interface of the automated air breathing trailer in a first configuration of the system and a view of an embodiment of the interface of the automated air breathing trailer in a second of the configuration system, respectively. In the shown embodiment, the automated breathing air trailer system 1000 comprises an electronic device in communication with the at least two air control units 2000, 2100, 2200, wherein the electronic device includes an automated control system adapted to control each of the air control units 2000, 2100, 2200. The automated control system comprises logic, that when executed by a processor causes the electronic device to: detect air pressure at the air source via an air source sensor, and detect air pressure at the outlet via an outlet sensor. Moreover, the electronic device is adapted to open or close the valve at either the first or second air control unit when certain pressure parameters at either the air source or the outlet fall below a safety threshold.

Specifically referring to FIG. 3, there is shown the automated breathing air trailer system 1000 in a first configuration. In the first configuration, the first air source 3000 is in fluid communication with the first air control unit 2000, The first air control unit 2000 has the valve 2020 open such that air flows from the air source 2000 to the SABA. As the pressure in the first air source 3000 drops to 20 kPag (as shown in FIG. 4), the second air control unit 2100 begins opening the valve 2120. In one embodiment, as the pressure in the first air source 3000 drops to 1000 kPag, the second air control unit 2100 begins opening the valve 2120 In this second configuration, the first valve 2020 is closed and the second valve 2120 is opened to maintain pressure at the SABA. The second valve 2120 is opened before the first valve 2020 is closed.

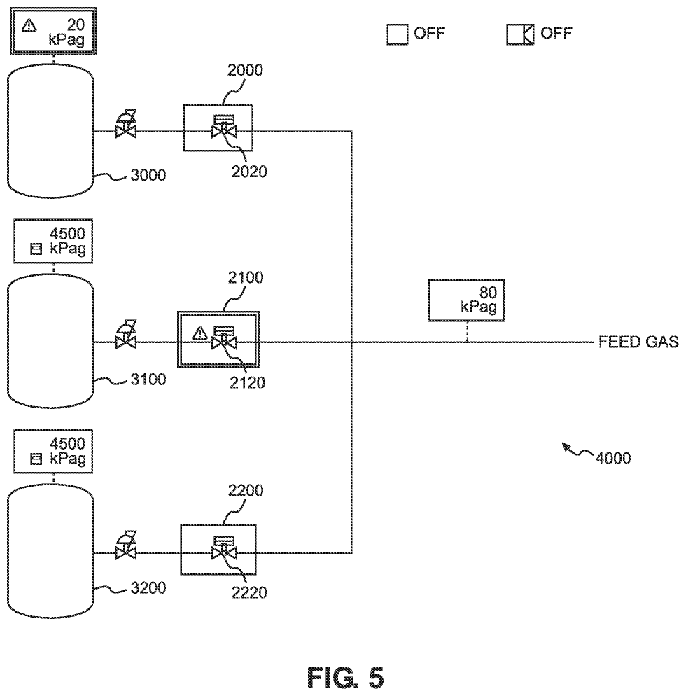

Referring now to FIG. 5, there is shown an embodiment of the interface of the automated air breathing trailer in a third configuration system. In the third configuration, one of the air control units 2100 has a failure that prevents air from flowing properly therethrough. The system detects the failure and automatically opens the valve 2220 of the third air control unit 2200. The system 1000 recognizes the pressure from the first air source 3000 remains low, below the threshold, so it does not attempt to open the valve 2020 of the first air control unit, as valve 2020 remains open. The system 1000 is adapted to recognize the state of each pressure and supply air from a new source when required.

As shown in FIGS. 3-6, the automated breathing air trailer system comprises an interface for manually controlling the automated control system. In the shown embodiment, the interface 4000 comprises a graphical user interface for interacting with the system to automatically switch configurations. In some embodiment, the interface 4000 comprises an interactive display for displaying the pressures and state of each air control unit. The interface includes icons 4100 to indicate the state of the valves (open, closed, and transitioning between open and closed). The interface also includes values and units of pressure at any and all positions of the system, including but not limited to the air sources, the air control units, and the SABA.

In one embodiment, when the pressure parameters at one of the air source drops below 30 kPag, then the system will automatically open a valve at the next air control unit and close the valve at the air control unit corresponding to the air source with the low pressure. In one embodiment, when the pressure parameters at the outlet (or downstream thereof) drops below 30 kPag, then the system will automatically open a valve at the next air control unit and close the valve at the air control unit corresponding to the air source with the low pressure. In alternative embodiments, the pressure parameters may be customized to the particular arrangement of the system 1000.

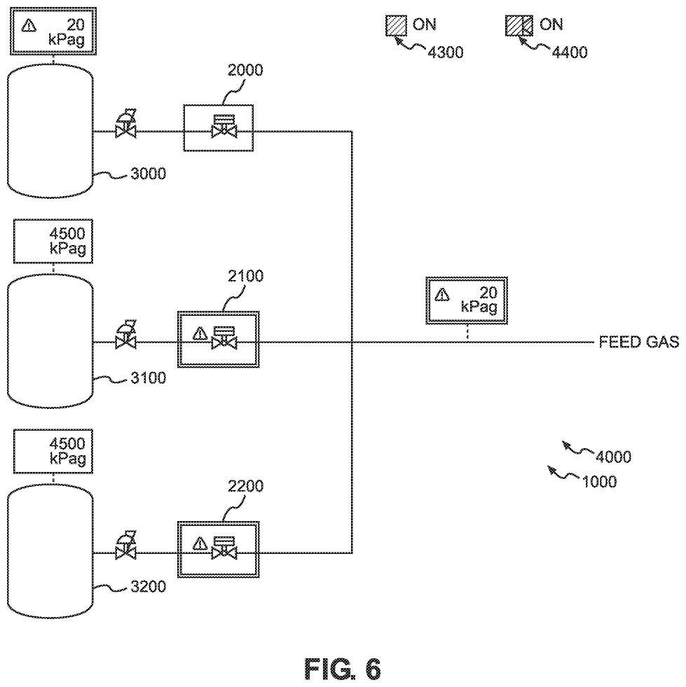

Referring now to FIG. 6, there is shown a view of an embodiment of the interface of the automated air breathing trailer in a fourth configuration of the system. In the shown embodiment, the air pressure at the SABA drops to 20 kPag, which is below the threshold. When the air pressure drops below the threshold, the system 1000 activates an alert mechanism. In the shown embodiment, the interface 4000 indicates that the system 1000 is operably connected to an audible alert 4400, such as a horn, and a visual alert 4300, such as lights. The system 1000 may be integrated into a vehicle or a control room at an industrial plant.

In one embodiment, the interface 4000 prevents manual override of the air control units 2000, 2100, 2200 when the manual selection would lower the pressure at the SABA. In other embodiments, the interface 4000 may prevent the opening and closing of certain valves if it would lower the pressure below the threshold.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly. all suitable modifications and equivalents may be resorted to. falling within the scope of the invention.

I claim:

1. An automated breathing air trailer system, comprising:
at least two air control units adapted to receive air from a first air source and a second air source, respectively, and wherein the first and second air sources are arranged in parallel;
wherein each air control unit comprises:
one or more interconnected pipes having an inlet for receiving air from the air supply and an outlet for sending air;
a valve for controlling the air flow through the air control unit and between the inlet and the outlet, wherein the valve is adapted to transition between an open position and a closed position;
wherein the open position, the air flows from the air source through the valve and the outlet;
wherein the closed position, the air is prevented from flowing through the valve;
an electronic device in communication with the at least two air control units, the electronic device having an automated control system adapted to control each of the air control units;
the automated control system having logic, that when executed by a processor causes the electronic device to:
detect air pressure at the air source via an air source sensor;
detect air pressure at the outlet via an outlet sensor;
open or close the valve at either the first or second air control unit when certain pressure parameters at either the air source or the outlet fall below safety threshold.

2. The automated breathing air trailer system of claim 1, further comprising a logic, wherein the logic of the automated breathing air trailer system causes the electronic device to:
identify the configuration of the system;
wherein a first configuration, the first air source is providing air to the outlet via an open valve at the first air control unit and a second air source is blocked via a closed valve at a second air control unit;
transition between the first configuration to a second configuration when air pressure at a first air source falls below the pressure parameter
wherein the second configuration, the second air source is providing air to the outlet via the open valve at the second air control unit and the first air source is blocked via a closed valve at the first air control unit.

3. The automated breathing air trailer system of claim 1, wherein the transition between the first configuration and the second configuration is gradual to regulate the outlet pressure to fall with a target pressure.

4. The automated breathing air trailer system of claim 2, wherein the outlet is adapted to fluidly connect to a manifold.

5. The automated breathing air trailer system of claim 1, wherein the automated control system is configured to keep a constant pressure within a target range of between 620-800 kPag through the outlet.

6. The automated breathing air trailer system of claim 1, wherein each air control unit further comprises a manual bypass that circumvents the valve, wherein the bypass comprises a pair of bypass stop valves positioned upstream and downstream of the valve to divert air from the air source to the outlet.

7. The automated breathing air trailer system of claim 1, wherein each air control unit further comprises a strainer positioned upstream of the valve.

8. The automated breathing air trailer system of claim 1, further comprising an interface for manually controlling the automated control system.

9. The automated breathing air trailer system of claim 8, wherein the interface comprises a graphical user interface for interacting with the system to automatically switch configuration.

10. The automated breathing air trailer system of claim 9, wherein the interface comprises an interactive display for displaying the pressures and state of each air control unit.

11. The automated breathing air trailer system of claim 2, wherein each air control unit is operably connected to a distinct air source, wherein each air source is a compressed air tank.

12. The automated breathing air trailer system of claim 2, wherein automated control system further comprises an alert mechanism to trigger if safety thresholds are not met.

13. The automated breathing air trailer system of claim 12, wherein the alert mechanism comprises an audible alert and a visual alert.

14. The automated breathing air trailer system of claim 2, wherein if the safety threshold is not met and the valves are open.

15. An automated breathing air trailer system, comprising:
an air control unit adapted to receive air from an air source;
the air control unit comprising:
one or more interconnected pipes having an inlet for receiving air from the air supply and an outlet for sending air;
a sensor configured to sense the air pressure within the air control unit;
a valve for controlling the air flow through the air control unit and between the inlet and the outlet, wherein the valve is adapted to transition between an open position and a closed position;
wherein the open position, the air flows from the air source through the valve and the outlet;
wherein the closed position, the air is prevented from flowing through the valve;
the air control unit configured to be in communication with an electronic device, the electronic device having an automated control system adapted to control the air control unit.

16. The automated breathing air trailer system of claim 15, wherein the air control unit is configured to be controlled via an automated control system, the automated control system having logic, that when executed by a processor causes the following:
detecting air pressure;
opening the valve when certain pressure parameters fall below safety threshold;
closing the valve when certain pressure parameters fall wither certain parameters.

17. The automated breathing air trailer system of claim 15, further comprising a manual bypass that circumvents the valve, wherein the bypass comprises a pair of bypass stop valves positioned upstream and downstream of the valve to divert air from the air source to the outlet.

18. The automated breathing air trailer system of claim 15, wherein the outlet is adapted to fluidly connect to a manifold for connecting to a SABA.
